(19) United States
(12) Patent Application Publication
(10) Pub. No.: US 2018/0143704 A1
(43) Pub. Date: May 24, 2018

(54) INCIDENT ANGLE OF A DIGITAL PEN WITH RESPECT TO A COMPUTING DEVICE

(71) Applicant: HEWLETT-PACKARD DEVELOPMENT COMPANY, L.P., HOUSTON, TX (US)

(72) Inventor: LEE WARREN ATKINSON, TAIPEI CITY (TW)

(21) Appl. No.: 15/563,977

(22) PCT Filed: Jun. 9, 2015
(86) PCT No.: PCT/US2015/034796

§ 371 Date: Oct. 3, 2017

(51) Int. Cl. G06F 3/0354; G06F 1/16; G06F 1/32; G06F 3/038

(52) U.S. Cl. CPC G06F 3/03545; G06F 1/1694; G06F 1/3231; G06F 3/038; G06F 1/1626; G06F 3/03547; G06F 1/3259

(57) ABSTRACT

Examples disclosed herein provide the ability to determine the incident angle of a digital pen against a writing surface, such as the touch sensitive surface of a computing device. One example includes receiving, from the digital pen, an orientation of the digital pen with respect to gravity. The example further includes determining an orientation of the computing device with respect to gravity, and comparing the orientations of the digital pen and the computing device to determine an incident angle of the digital pen with respect to the computing device. The example further includes interpreting communications from the digital pen to the computing device based on the incident angle.

### BACKGROUND

The emergence and popularity of mobile computing has made portable computing devices, due to their compact design and light weight, a staple in today's marketplace. Tablet computers and all-in-one devices are examples of portable computing devices that are widely used. Tablet computers and all-in-one devices, generally referred to as touch sensitive devices, employ a touchscreen on a display surface of the device that may be used for both viewing and input.

### BRIEF DESCRIPTION OF THE DRAWINGS

FIGS. 1A-B illustrate incident angles of a digital pen with respect to a computing device, according to an example;

FIGS. 2A-B illustrate incident angles of the digital pen with respect to the computing device at a different orientation, according to an example;

FIGS. 3-4 are flow diagrams in accordance with examples of the present disclosure; and

FIG. 5 is a block diagram illustrating the computing device described above, according to an example.

### DETAILED DESCRIPTION

A touch sensitive device can include a touch sensor panel, which can be a clear panel with a touch sensitive surface, and a display device, such as a liquid crystal display (LCD), that can be positioned partially or fully behind the panel or integrated with the panel so that the touch sensitive surface can cover at least a portion of the viewable area of the display device. The touch sensitive device can allow a user to perform various functions by touching the touch sensor panel using a finger, digital pen, or other object at a location often dictated by a user interface (UI) being displayed by the display device. In general, the touch sensitive device can recognize a touch event and the position of the touch event on the touch sensor panel, and the touch sensitive device can then interpret the touch event in accordance with the display appearing at the time of the touch event, and thereafter can perform one or more actions based on the touch event. As touch sensing technology continues to improve, touch sensitive devices are increasingly being used to compose and mark-up electronic documents. In particular, styluses have become popular input devices as they emulate the feel of traditional writing instruments.

Examples disclosed herein provide the ability to determine the incident angle of a digital pen against a writing surface, such as the touch sensitive surface of a computing device. As will be further described, upon determining the incident angle of the digital pen against the writing surface, the digital pen can be used for parallax correction or artistic effect on the writing surface, or for power management, as examples. In addition, by relying upon motion sensors disposed within the digital pen, power management of the digital pen may be optimized.

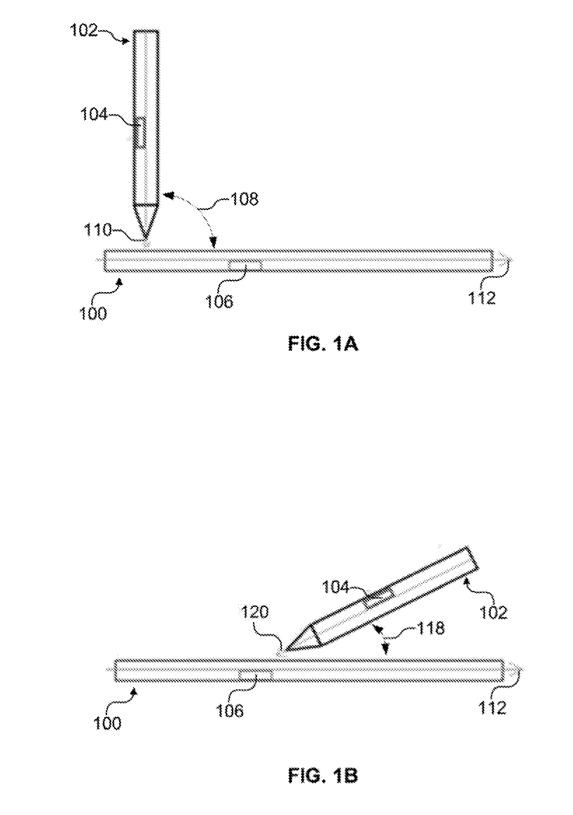

With reference to the figures, FIGS. 1A-B illustrate incident angles of a digital pen 102 with respect to a computing device 100, according to an example. The computing device 100 may be a touch sensitive device, such as a tablet computer, all-in-one device, laptop computer, desktop computer, mobile device, cellular phone, wearable computing device, retail point of sale device, workstation, thin client, gaming device, among others. As an example, communications between the digital pen 102 and the computing device 100 may be determined based on the incident angle of the digital pen 102 with respect to the touch sensitive surface of the computing device 100. For example, the computing device 100 may interpret communications or input from the digital pen 102 to the computing device 100 based on the incident angle.

As an example, with regards to parallax correction, upon determining the incident angle of the digital pen 102 upon the touch sensitive surface of the computing device 100, parallax associated with the tilt of the digital pen 102 on the touch sensitive surface of the computing device 100 may be accounted for. In addition, the incident angle may determine the artistic effect of input provided by the digital pen 102. For example, the incident angle may be used to emulate the width of a brush. In addition to modifying input provided by the digital pen 102, the incident angle may be used for power management purposes. For example, if the incident angle is below a threshold amount, suggesting that the digital pen 102 may be lying flat on the touch sensitive surface of the computing device 100, the touchscreen of the computing device 100 may revert to a touch mode, and not an active pen mode, thereby conserving power. In addition to the computing device 100 conserving power, the digital pen 102 may also conserve power by turning off a transmitter of the digital pen 102 when the incident angle between the digital pen 102 and the writing surface of the computing device 100 is below a threshold amount.

As an example, in order to determine the incident angle of the digital pen 102 with respect to the computing device 100, orientations of the digital pen 102 and the computing device 100 may be determined first. As illustrated, the computing device 100 may include motion sensors 106 disposed within for determining the orientation or tilt of the computing device 100. Similarly, the digital pen 102 may include motion sensors 104 disposed within for determining the orientation or tilt of the digital pen 102. As an example, the motion detectors 104, 106 for detecting the orientations of the digital pen 102 and the computing device 100, respectively, may include accelerometers for detecting orientations with respect to gravity. The orientations of the digital pen 102 and the computing device 100 may then be compared to each other in order to determine the incident angle of the digital pen 102 with respect to the touch sensitive surface of the computing device 100, as will be further described.

Examples of other motion sensors include, but are not limited to, a compass and a gyroscope, that may be used alone or in combination. As an example, a compass in the digital pen 102 and a compass in the computing device 100 may be used to determine the relative rotation of the digital pen 102 with respect to the computing device 100. The relative rotation may determine the artistic effect of input provided by the digital pen 102.

Referring to FIG. 1A, for detecting the tilt of the digital pen 102, the motion sensor 104 (e.g., an accelerometer) detects the relative alignment or orientation of the digital pen 102 to the pull of gravity, indicated by arrow 110. As illustrated, when the digital pen 102 is pointing down and parallel to the pull of gravity 110, the accelerometer 104 disposed within the digital pen 102 may detect 1 G. However, when the digital pen 102 is pointed directly up (against the pull of gravity 110), the accelerometer 104 disposed within the digital pen 102 may report −1 G. The angle relative to the earth's horizon (e.g., the X axis) may be calculated as 0 gravity (0 G). When the digital pen 102 is at an angle (e.g., see FIG. 1B), the accelerometer 104 disposed within the digital pen 102 may sense a value between 0 G and 1 G, with the polarity indicating whether the digital pen 102 is pointing up or down.

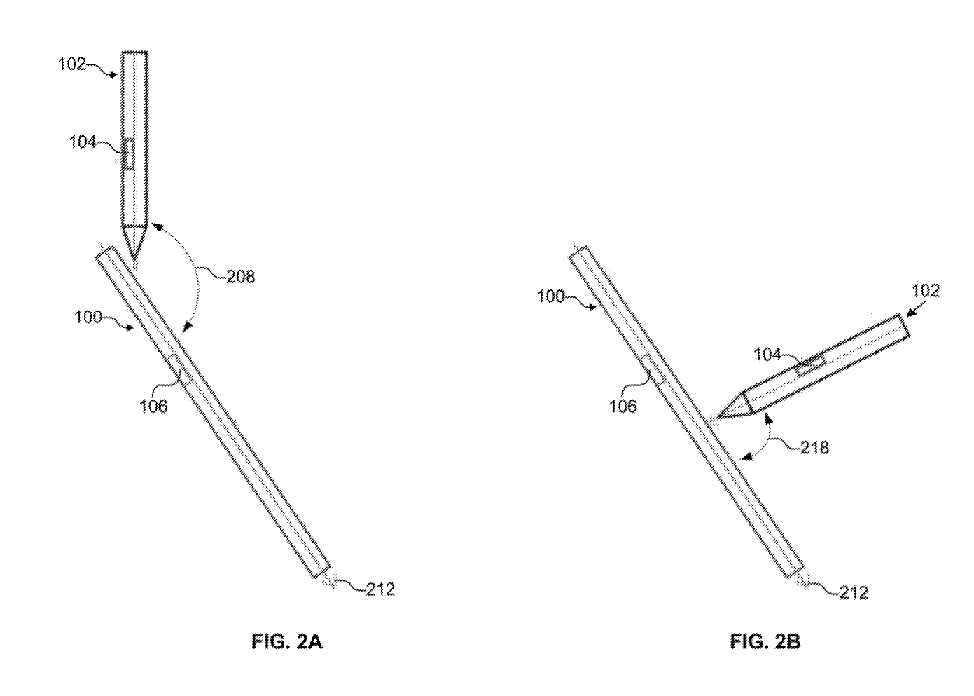

Similar to the digital pen 102, the motion sensor 106 (e.g., an accelerometer) disposed within the computing device 100 may detect the relative alignment of the computing device 100, particularly its touch sensitive surface, to the pull of gravity. As illustrated in FIGS. 1A-B, when the computing device 100 is lying flat horizontally, for example on a table, the accelerometer 106 detects 0 G, indicating that the computing device 100 is perpendicular to earth's gravity (indicated by arrow 112). However, when the computing device 100 is tilted (e.g., see FIGS. 2A-B), the accelerometer 106 may read a value between 0 G and 1 G (unless upside down, where the accelerometer 106 may read between 0 G and −1 G).

Once the angle of each component, including the digital pen 102 and the computing device 100, is known with respect to gravity, the resultant angle or incident angle between these components may be calculated. Referring to FIG. 1A, the accelerometer 104 disposed within the digital pen 102 may determine the orientation or tilt of the digital pen to be 1 G. Similarly, the accelerometer 106 disposed within the computing device 100 may determine the orientation or tilt of the computing device to be 0 G. As a result, the resultant angle 108 between the digital pen 102 and the computing device 100 may be 90 degrees. Upon detecting the incident angle of the digital pen 102 with respect to the computing device 100, the computing device 100 may interpret communications from the digital pen 102 to the computing device 100 based on an incident angle of 90 degrees.

Referring to FIG. 1B, as the digital pen 102 is pointing at an angle with respect to the touch sensitive surface of the computing device 100, indicated by arrow 120, the accelerometer 104 disposed within the digital pen 102 may determine the orientation of the digital pen 102 with respect to gravity to be a value between 0 G and 1 G. Similarly, the accelerometer 106 disposed within the computing device 100 may determine the orientation or tilt of the computing device to be 0 G, as in FIG. 1A. As a result, the resultant angle 118 between the digital pen 102 and the computing device 100 may be between 0 and 90 degrees (e.g., 45 degrees).

Comparing the incident angles illustrated in FIGS. 1A-B, where the incident angle changes from 90 degrees to an angle below 90 degrees (e.g., 45 degrees), the computing device may reinterpret communications from the digital pen 102 to the computing device 100 based on the reduced incident angle. As an example, parallax associated with the reduced tilt of the digital pen 102 on the touch sensitive surface of the computing device 100 may be accounted for. In addition, the incident angle may determine the artistic effect of input provided by the digital pen 102. For example, the incident angle may be used to emulate the width of a brush. As an example, the computing device 100 may provide the value of the incident angle to an application stored on the computing device 100, to handle inputs from the digital pen 102, by taking the incident angle into consideration.

As certain touch sensitive devices are particularly mobile, such as tablet computers, the orientation or tilt of the touch sensitive device itself may change, causing dynamic changes in the incident angle between a digital pen and the touch sensitive device. Referring to FIGS. 2A-B, in addition to the digital pen 102 changing orientations, the computing device 100 itself may also change orientations, for example, from the horizontal orientation illustrated in FIGS. 1A-B. As an example, the motion sensor 106 (e.g., an accelerometer) disposed within the computing device 100 may detect the relative alignment of the computing device 100, particularly its touch sensitive surface, to the pull of gravity. As illustrated in FIGS. 2A-B, when the computing device 100 is tilted (indicated by arrow 212), the accelerometer 106 may read a value between 0 G and 1 G (unless upside down, where the accelerometer 106 may read between 0 G and −1 G).

Referring to FIG. 2A, the accelerometer 104 disposed within the digital pen 102 may determine the orientation or tilt of the digital pen to be 1 G. As the accelerometer 106 disposed within the computing device 100 may determine the orientation or tilt of the computing device to be 0 G and 1 G, the resultant angle 208 between the digital pen 102 and the computing device 100 may be, for example, around 135 degrees.

Referring to FIG. 2B, the accelerometer 104 disposed within the digital pen 102 may determine the orientation of the digital pen 102 with respect to gravity to be a value between 03 and 10 G. As the accelerometer 106 disposed within the computing device 100 may determine the orientation or tilt of the computing device to be 0 G and 1 G, the resultant angle 218 between the digital pen 102 and the computing device 100 may be, for example, around 90 degrees.

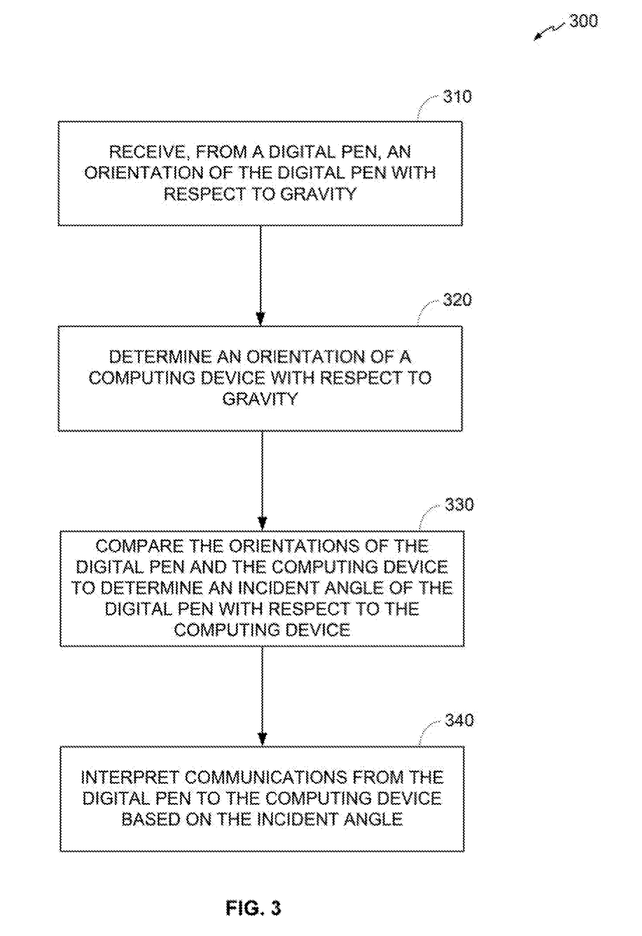

Referring to FIG. 3, a flow diagram is illustrated in accordance with various examples. The flow diagram illustrates, in a particular order, processes for determining the incident angle of a digital pen with respect to a computing device, particularly the touch sensitive surface of the computing device. The order of the processes is not meant to limit the disclosure. Rather, it is expressly intended that one or more of the processes may occur in other orders or simultaneously. The disclosure is not to be limited to a particular example.

A method 300 may begin and progress to 310, where a computing device may receive, from a digital pen, an orientation of the digital pen with respect to gravity. As described above, the orientation of the digital pen with respect to gravity may be determined based on motion sensors disposed within the digital pen, such as an accelerometer. As an example, the digital pen may wirelessly report its axial orientation to a receiver in the computing device. For example, the touchscreen of the computing device may receive the wireless broadcast from the digital pen. As an example, the digital pen may include an active or passive circuit for generating a signal that is detected by the computing device.

Progressing to 320, the computing device itself may determine an orientation of the computing device with respect to gravity. Similar to the digital pen, the computing device may include motion sensors disposed within the computing device, in order to determine the orientation of the computing device with respect to gravity.

Progressing to 330, the computing device may compare the orientations of the digital pen and the computing device to determine an incident angle of the digital pen with respect to the computing device. As an example, a processor in the computing device may compare the orientations of the digital pen to the computing device, and calculate the incident angle of the digital pen on the touch sensitive surface of the computing device.

Progressing to 340, the computing device may interpret communications from the digital pen to computing device based on the incident angle. As an example, the computing device 100 may provide the value of the incident angle to an application stored on the computing device 100, to handle inputs from the digital pen 102, by taking the incident angle into consideration. An example includes a drawing application determining which artistic effect to apply to input provided by the digital pen. For example, the incident angle of the digital pen against the touch sensitive surface of the computing device may inform the drawing application to emulate the width of a brush that is desired by a user. With regards to parallax correction, upon determining the incident angle of the digital pen upon the touch sensitive surface of the computing device, parallax associated with the tilt of the digital pen on the touch sensitive surface of the computing device may be accounted for.

In addition to modifying input provided by the digital pen, the incident angle may be used for power management purposes. As an example, interpreting communications from the digital pen to the computing device based on the incident angle may include alternating between different modes of input from the digital pen. For example, if the incident angle is below a threshold amount, suggesting that the digital pen may be lying flat on the touch sensitive surface of the computing device, the touchscreen of the computing device may revert to a touch mode, and not an active pen mode, thereby conserving and optimizing power of the computing device.

In addition to the computing device conserving power, the digital pen may also conserve or optimize power by powering down the digital pen, for example, by turning off a transmitter of the digital pen, when the incident angle between the digital pen and the writing surface of the computing device 100 is below a threshold amount. The digital pen may be reenabled, for example, by powering back on the transmitter of the digital pen, when the incident angle of the digital pen with respect to the computing device is changed to be greater than the threshold amount, or when the digital pen is to be repositioned in a previously used writing position.

Although steps have been described above to manage the power of the digital pen based according to the incident angle of the digital pen with respect to the touch sensitive surface of the computing device, power management of the digital pen may also be possible by relying solely on the motion sensors disposed within the digital pen itself. Referring to FIG. 4, a flow diagram is illustrated in accordance with various examples. The flow diagram illustrates, in a particular order, processes for power management of the digital pen. The order of the processes is not meant to limit the disclosure. Rather, it is expressly intended that one or more of the processes may occur in other orders or simultaneously. The disclosure is not to be limited to a particular example.

A method 400 may begin and progress to 410, where the digital pen may recognize movement of the digital pen using motion sensors disposed within the digital pen. As an example, the motion sensors include an accelerometer. However, other motion sensors, such as a compass and a gyroscope, alone or in combination, may be used for recognizing movement of the digital pen. As an example, recognizing movement of the digital pen generally includes detecting a movement along an axis of the digital pen suggesting a downward movement of a tip of the digital pen. The downward movement of the tip of the digital pen may indicate a user's desire to interact with or write on the touch sensitive surface of a computing device. As an example, the movement may also correspond to random movements or gestures involving the digital pen.

Progressing to 420, upon recognizing movement of the digital pen, the digital pen may enable a transmitter of the digital pen that interacts with a touch sensitive surface of the computing device. As an example, when the digital pen no longer detects movement via the motion sensors, the digital pen may then power down the transmitter. Power managing the digital pen as described may prevent power consumption by the digital pen when it appears that the digital pen is not be used to interact with the computing device. As an example, if the motion sensors disposed within the digital pen determines the digital pen is repositioned in a previously used writing position, the digital pen may reenable the transmitter.

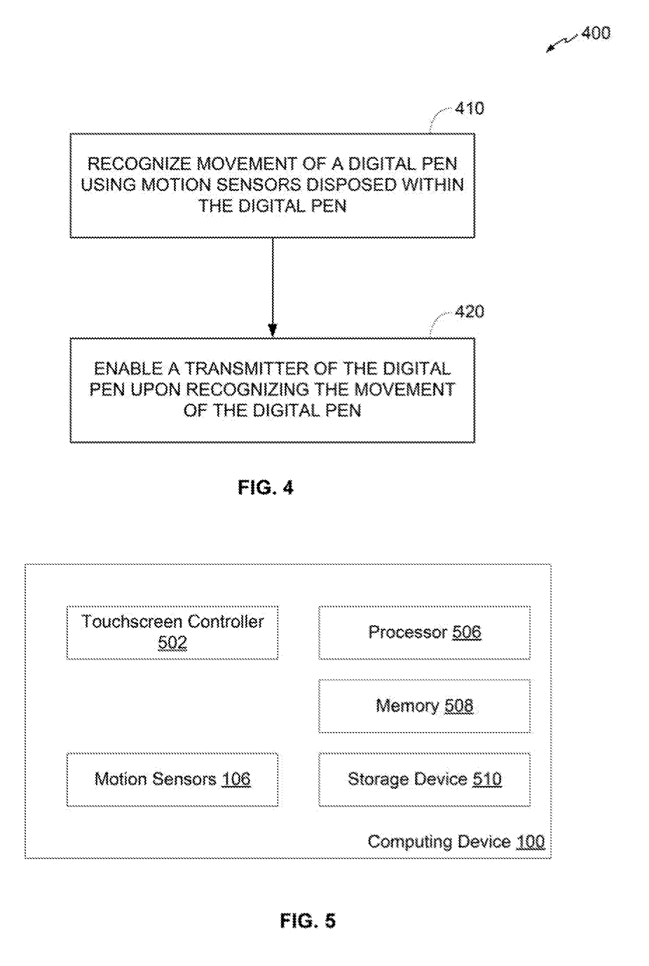

FIG. 5 is a block diagram illustrating the computing device 100 described above, according to an example. As illustrated, the computing device 100 includes a touchscreen controller 502 for controlling the touchscreen of the computing device 100. As described above, the touchscreen controller 502 may switch the computing device 100 between a touch mode and an active pen mode, based on the incident angle of a digital pen on the touchscreen of the computing device 100. For example, if the incident angle is below a threshold amount, suggesting that the digital pen may be lying flat on the touch sensitive surface of the computing device 100, the touchscreen controller 502 may revert the touchscreen of the computing device 100 to a touch mode, and not an active pen mode, thereby conserving power.

The computing device 100 also includes a processor 506 and a storage device 510. The components of the computing device 100 may be connected and communicate through a system bus (e.g., PCI, ISA, PCI-Express, HyperTransport®, NuBus, etc.). The processor 506 can be a single core processor, a multi-core processor, a computing duster, or any number of other configurations. The processor 506 may be implemented as Complex Instruction Set Computer (CISC) or Reduced Instruction Set Computer (RISC) processors, x86 Instruction set compatible processors, multi-core, or any other microprocessor or central processing unit (CPU). As an example, the main processor 506 includes dual-core processor(s), dual-core mobile processor(s), or the like.

The computing device 100 may include a memory device 508. The memory device 508 can include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory systems. The storage device 510 may be a non-transitory computer-readable storage medium. The storage device 510 may have instructions stored thereon that, when executed by a processing resource, such as the processor 506, cause the computing device 100 to perform operations. As an example, the operations may be executed by the touchscreen controller 502. The touchscreen controller 502 can be implemented in hardware, implemented as machine-readable instructions executable on the processor(s) 506, or implemented as a combination of hardware and machine-readable instructions. In examples where the touchscreen controller 502 is implemented at least in part with machine-readable instructions, these machine-readable instructions can be in the form of software executable on the processor(s) 506, or software or firmware executable by processors in the touchscreen controller 502.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method comprising:
receiving, from a digital pen, an orientation of the digital pen with respect to gravity;
determining an orientation of a computing device with respect to gravity;
comparing the orientations of the digital pen and the computing device to determine an incident angle of the digital pen with respect to the computing device; and
interpreting communications from the digital pen to the computing device based on the incident angle.

2. The method of claim 1, wherein the orientation of the digital pen with respect to gravity is determined based on motion sensors disposed within the digital pen, and the orientation of the computing device with respect to gravity is determined based on motion sensors disposed within the computing device.

3. The method of claim 2, wherein the motion sensors disposed within the digital pen and the computing device comprise accelerometers.

4. The method of claim 1, wherein interpreting communications from the digital pen to the computing device based on the incident angle comprises alternating between different modes of input from the digital pen.

5. The method of claim 1, comprising powering down the digital pen when the incident angle of the digital pen with respect to the computing device is less than a threshold amount.

6. The method of claim 5, comprising reenabling the digital pen when the digital pen is to be repositioned in a previously used writing position.

7. The method of claim 5, comprising reenabling the digital pen when the incident angle of the digital pen with respect to the computing device is changed to be greater than the threshold amount.

8. A method comprising:
recognizing movement of a digital pen using motion sensors disposed within the digital pen; and
enabling a transmitter of the digital pen upon recognizing the movement of the digital pen.

9. The method of claim 8, wherein the motion sensor disposed within the digital pen comprises an accelerometer.

10. The method of claim 8, wherein recognizing the movement of the digital pen comprises detecting a movement along an axis of the digital pen suggesting a downward movement of a tip of the digital pen.

11. The method of claim 8, comprising powering down the transmitter when movement of the digital pen is no longer detected by the motion sensors.

12. The method of claim 11, comprising reenabling the digital pen when the digital pen is to be repositioned in a previously used writing position.

13. A non-transitory computer-readable storage medium comprising programming instructions which, when executed by a processor, to cause the processor to:
receive, from a digital pen, an orientation of the digital pen with respect to gravity;
determine an orientation of a computing device with respect to gravity;
compare the orientations of the digital pen and the computing device to determine an incident angle of the digital pen with respect to the computing device; and
alternate the computing device between different modes of input from the digital pen based on the incident angle.

14. The non-transitory computer-readable storage medium of claim 13, wherein the orientation of the digital pen with respect to gravity is determined based on motion sensors disposed within the digital pen, and the orientation of the computing device with respect to gravity is determined based on motion sensors disposed within the computing device.

15. The non-transitory computer-readable storage medium of claim 14, wherein the motion sensors disposed within the digital pen and the computing device comprise accelerometers.
